(19) United States
(12) Patent Application Publication
(10) Pub. No.: US 2017/0039086 A1
(43) Pub. Date: Feb. 9, 2017

(54) SELECTING A SUITABLE TIME TO DISRUPT OPERATION OF A COMPUTER SYSTEM COMPONENT

(71) Applicant: LinkedIn Corporation, Mountain View, CA (US)

(72) Inventors: Zhenyun Zhuang, Belmont, CA (US); Min Shen, Sunnyvale, CA (US); Haricharan K. Ramachandra, Fremont, CA (US); Cuong H. Tran, Los Altos, CA (US); Suja Viswesan, San Jose, CA (US); Badrinath K. Sridharan, Saratoga, CA (US)

(73) Assignee: LinkedIn Corporation, Mountain View, CA (US)

(21) Appl. No.: 14/816,922

(22) Filed: Aug. 3, 2015

(51) Int. Cl. G06F 9/46

(52) U.S. Cl. CPC G06F 9/46

(57) ABSTRACT

A system, method, and apparatus are provided for determining an appropriate time to disrupt operation of a computer system, subsystem, or component, such as by shutting it down or taking it offline. Historical measurements of work accumulated on the component at different times are used to generate one or more forecasts regarding future amounts of work that will accumulate at different times. Accumulated work may include all job/tasks (or other executable objects) that have been initiated but not yet completed at the time the measurement is taken, and may be expressed in terms of execution time and/or component resources (e.g., cpu, memory). When a request is received to disrupt component operations, based on an urgency of the disruption a corresponding accumulated work threshold is chosen to represent the maximum amount of accumulated work that can be in process and still allow the disruption, and the disruption is scheduled accordingly.

### BACKGROUND

This disclosure relates to the field of computer systems. More particularly, a system, method, and apparatus are provided for determining a suitable time to disrupt operation of a computer system or a computer system component, to perform maintenance, apply an upgrade, or for some other reason.

Most computer systems and computer system components require regular or periodic disruptions to their operations, in order to replace failed elements, perform software and/or hardware updates, and/or for other reasons. Taking the system or system component offline invariably means that new jobs or tasks cannot be started while the system or component is offline, and also means that any jobs or tasks that were in process will be aborted and may need to be restarted.

Typically, when a system or system component must be taken offline, the responsible operator or administrator will try to schedule such action for a time when the fewest jobs are running, in the hope of disrupting as few as possible. While this strategy may reduce the number of jobs that are disrupted, it fails to take into account the waste in resources that will result from aborting jobs that were executing or pending.

### DESCRIPTION OF THE FIGURES

FIG. 1 is a block diagram depicting a computing environment in which a disruption to the operation of a computing system component may be scheduled according to an actual or projected level of accumulated work, in accordance with some embodiments.

FIG. 2 is a flow chart illustrating a method of scheduling a disruption to the operation of a computing system component based on an actual or projected level of accumulated work, in accordance with some embodiments.

FIG. 3 is an illustrative forecast of work accumulation on a computing system component, according to some embodiments.

FIG. 4 depicts an apparatus for scheduling a disruption to the operation of a computing system component based on an actual or projected level of accumulated work, in accordance with some embodiments.

### DETAILED DESCRIPTION

The following description is presented to enable any person skilled in the art to make and use the disclosed embodiments, and is provided in the context of one or more particular applications and their requirements. Various modifications to the disclosed embodiments will be readily apparent to those skilled in the art, and the general principles defined herein may be applied to other embodiments and applications without departing from the scope of those that are disclosed. Thus, the present invention or inventions are not intended to be limited to the embodiments shown, but rather are to be accorded the widest scope consistent with the disclosure.

In some embodiments, a system, method, and apparatus are provided for identifying a suitable time to take offline (or shut down) a computer system, a system component, or a subsystem, based on the accumulated processing or work that was performed and/or in process before the shutdown (some or all of which may have to be re-executed).

For example, when a data processing or computational cluster, system, or subsystem must be taken offline for maintenance or to perform an upgrade, the action may be scheduled for a time when relatively little work has been accomplished by jobs or tasks that were submitted prior to the scheduled time. Because this work may have to be re-executed when the system component is once again online, minimizing the amount of work that is pending or that has accumulated at the time of the shutdown will result in the least waste of system resources, considering both past and future operations.

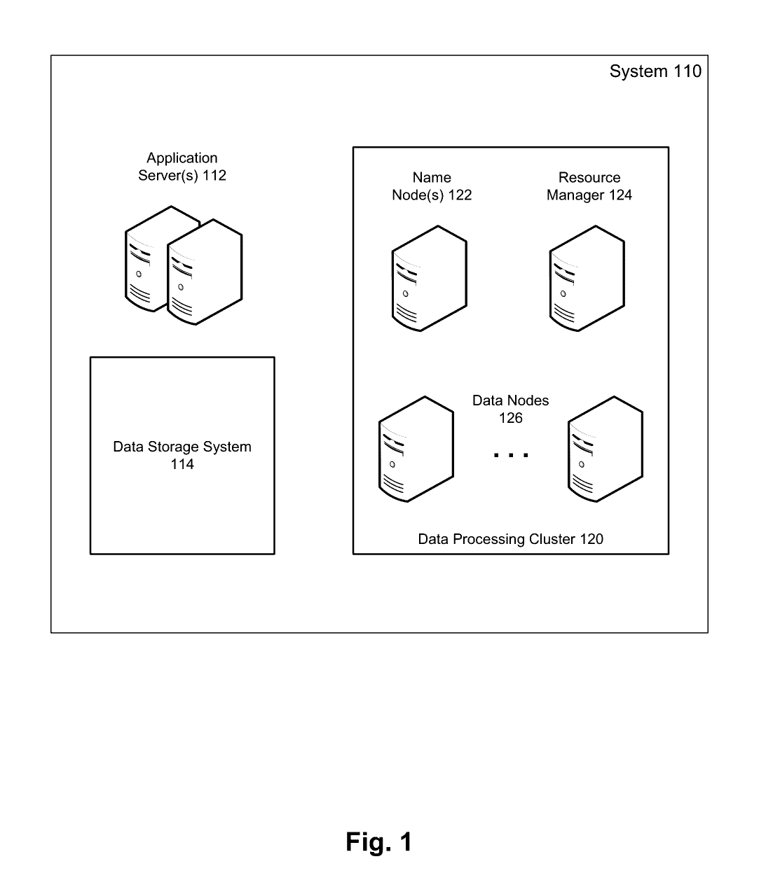

FIG. 1 is a block diagram depicting a computing environment in which a disruption to the operation of a system component may be scheduled according to an actual or projected level of accumulated work, in accordance with some embodiments.

System 110 of FIG. 1 is (or is part of) a data center, and includes different components in different embodiments. In the illustrated embodiments, the system includes server(s) 112 for hosting one or more applications and/or services, data storage system 114 (e.g., a distributed storage system that includes one or more data storage devices or components) for storing data used by server(s) 112 and/or other components of system 110, and data processing cluster 120. Components of data processing cluster 120 may have different labels in computing environments other than that depicted in FIG. 1.

Data processing (or computational) cluster 120 supports distributed processing of data, especially very large data sets. In illustrative embodiments, cluster 120 includes at least one name node 122 that manages the name space of a file system or file systems distributed across data nodes 126, of which there may be tens, hundreds, or thousands. Each data node 126 includes one or more types of data storage devices (e.g., memory, solid state drives, disk drives).

Jobs submitted to the cluster are divided or partitioned into any number of tasks, which are distributed among the data nodes for processing. A typical job in an illustrative embodiment may spawn one or more mapper tasks that process (raw) data, and usually a set of reducer tasks that process the output of the mapper tasks.

Resource manager 124 schedules jobs by assigning them and/or the tasks spawned on behalf of the jobs to individual data nodes. Each data node executes management logic (e.g., an application master, a node manager) for scheduling and executing tasks. The resource manager and/or individual data nodes may track the usage of resources during execution of jobs/tasks (e.g., execution time, processor time, memory, disk space, communication bandwidth). Resource manager 124 may therefore be termed a Job Tracker because it tracks the completion of jobs received at cluster 120 (e.g., from users, clients), and individual data nodes may be termed Task Trackers for their roles in tracking completion of their assigned tasks.

It may be noted that, until all tasks associated with a given job have completed, the job itself is still pending or in progress. Thus, from the time the job is accepted until it is complete, associated work involving that job will accumulate and, if the cluster is shutdown or taken offline after the job begins, but before its last task completes, the work that has been performed will be wasted, thereby diminishing the cluster's job throughput.

Specifically, accumulated work associated with a given job at a particular point in time encompasses all execution time and/or resource usage of tasks spawned by or for the job that are (a) still executing at that point in time, (b) completed (assuming at least one of the job's other tasks has not yet completed execution), and (c) waiting to begin execution or to continue execution.

System 110 and all components, subsystems, clusters, and/or other entities that are part of system 110 are subject to occasional downtime for the purpose of upgrading hardware and/or software, installing new hardware/software, replacing or repairing defective equipment, changing a configuration, and/or for other purposes. During this downtime, the affected entity or entities are offline and cannot be used for their normal operational purpose(s).

The terms “system,” “system component,” “subsystem” and/or other terms that identify equipment within a computing environment are used interchangeably herein to refer to any entity whose operation may need to be disrupted, and it should be recognized that use of one term in describing an embodiment is intended to encompass other types as well. For example, some embodiments are described as they may be implemented to schedule a disruption to the operation of data processing cluster 120 of FIG. 1, which comprises multiple components. These embodiments may be applied similarly to schedule disruptions for other “components,” such as a name node or resource manager of cluster 120, an application server 112, data storage system 114, the entire system 110, and so on.

System 110 may include other elements not depicted in FIG. 1. For example, the system may include a dedicated server, computer system, or other component for scheduling downtime, gathering statistics regarding resource usage or accumulated work on system components and/or using such statistics to profile or model usage of the components, and/or for other purposes. Alternatively, individual components of system 110 (e.g., data processing cluster 120) may include elements for performing some or all of these functions.

Although only a single instance of a particular component of system 110 may be illustrated in FIG. 1, it should be understood that multiple instances of some or all components may be employed.

In some embodiments, the amount of accumulated work or processing that has been performed for jobs/tasks pending on a component is used to select a suitable time for disrupting operation of that component by taking it offline or shutting it down. In particular, the selected time may be when relatively little work has accumulated, even if the number of jobs/tasks that are executing is relatively large.

In these embodiments, historical levels of work accumulated at different times are used to profile work accumulation within a given computing component. For example, during some extended period of time (e.g., day(s), week(s), month(s)), work accumulated within a component may be monitored and/or recorded during some number of regular intervals (e.g., every second, multiple seconds, every minute, multiple minutes, every hour).

Based on observed work accumulations, a seasonal pattern may be detected that facilitates prediction or modeling of future work accumulations. For example, week days may exhibit similar patterns of work accumulation that are different than weekend days, thereby providing one prediction for future week days, and one prediction for future weekend days. Or, individual days may exhibit recurring patterns week-to-week, so that one prediction or model may be used for Mondays, another for Tuesdays, etc.

Historical measures of work accumulation for any number of system components may thus be captured for any period of time, with any desired granularity. From these observations, models may be applied to predict how much work will likely accumulate on those components at different times in the future. Based on predicted work accumulation, a suitable time for disrupting a system component may be selected.

In addition to or instead of generating models forecasting future work accumulation, work accumulation may be monitored in real time to take advantage of current conditions on a dynamic basis. In this case, for example, a system component may be taken offline or shutdown opportunistically when a suitable (e.g., relatively low) level of work accumulation is observed.

A requirement or request to disrupt operation of a component (e.g., by taking it offline or shutting it down) may include or be assigned a corresponding urgency, which illustratively may be (or may be used to identify) a time frame or window during which the disruption should or must be implemented (e.g., immediately, within a few hours, sometime during a longer period of time).

Also, the urgency of the disruption may identify or be mapped to a corresponding threshold level of work accumulation above which the component should not be taken offline. In other words, the greater the urgency, the more accumulated work that may be forfeited to satisfy the disruption request. The lower the urgency, the lower the accumulated work must be in order to perform the disruption.

If the time frame allows (e.g., an immediate or emergency disruption is not necessary), a forecast of future work accumulation may then be consulted to schedule the disruption for a time that is expected to exhibit the selected work accumulation threshold.

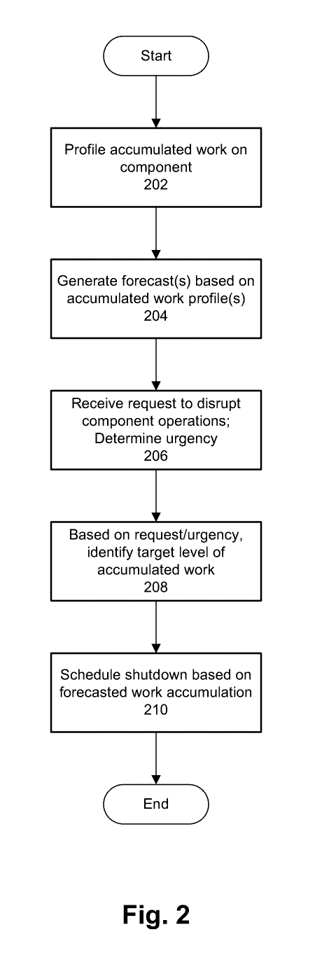

FIG. 2 is a flow chart illustrating a method of scheduling a disruption to the operation of a computing system component based on an actual or projected level of accumulated work, according to some embodiments. In other embodiments, one or more of the illustrated operations may be omitted, repeated, and/or performed in a different order. Accordingly, the specific arrangement of steps shown in FIG. 2 should not be construed as limiting the scope of the embodiments.

In these embodiments, the system component whose normal operation will be disrupted is a data processing (or computational) cluster, such as cluster 120 of FIG. 1, and the disruption will cause the cluster to be completely unavailable to users. In other embodiments, a disruption to operation of some other type of component is to be arranged.

In operation 202, statistics regarding work accumulated within the cluster are collected at multiple intervals. For example, every second, every minute, every few minutes (e.g., 5, 10, 15, 30), every hour, or with some other regularity, a measure of the amount of resources in use within the cluster may be recorded. This measure of accumulated work may therefore be expressed in terms of cpu cycles, communication bandwidth, storage space (e.g., memory and/or secondary storage), and/or other resource-related metrics.

Also, or instead, the execution or processing times for all tasks currently scheduled or in process on the component are collected. As indicated above, one or more “tasks” are spawned to handle a given “job” received from a client or a user of the component, and the work involved in completing that job comprises the aggregated work performed by its tasks. Thus, if three tasks created for one job are pending at a particular time, one of which has been executing for 30 minutes, one for 35 minutes, and one for 40 minutes, the accumulated work for that job may be recorded as 105 minutes or task-minutes.

However, because a given job may spawn multiple tasks that may finish at different times, accumulated work for a given job will also include the execution time of tasks that have finished and/or that are waiting to begin or continue execution. Thus, for the job above, if two other tasks have already completed, which took 15 minutes and 20 minutes to execute, respectively, the total accumulated work for the job is 140 minutes or task-minutes.

Terms other than “jobs” and “tasks” may be used in other embodiments, but measuring the amount of accumulated work will generally involve examining the resource usage, execution time, processing time, and/or other metric of the lowest-level associated processes (referred to herein as tasks), and aggregating them to form one accumulated work value.

In some embodiments, a logical construct such as a “container” (e.g., a Java® virtual machine) may be instantiated for each data processing task created on a data node within the cluster. In this case, a measure of accumulated work for each job that has not yet completed execution may involve aggregating the ages of every task container that was created for the job's tasks.

In short, the total accumulated work among all jobs executing on the component may be measured in terms of execution time and/or resource usage, and is measured or collected at various times. These measurements, or aggregations or results thereof, serve as a profile of work accumulation observed on the component over time.

In operation 204, based on the accumulated work profile, one or more suitable models may be applied to generate any number of forecasts regarding probable levels of accumulated work that will be experienced in the future. In different embodiments, different types of models may be used, such as a time-series model, a state-space model, regression analysis, and so on, and different specific models (e.g., Holt-Winters, ARIMA (Autoregressive Fractionally Integrated Moving Average)).

In some implementations, a forecast may reflect a seasonal pattern observed in the historical measures of accumulated work. A given pattern may correspond to any period of time, such as a workday (e.g., several hours), a day, multiple days, an entire week, etc. Thus, a given pattern may identify forecasted work accumulations at different intervals (e.g., hours, half hours, quarter hours) during the period of time corresponding to the model.

In some embodiments, a forecast takes the form of a probability distribution function (PDF). In these embodiments, the accumulated work observations or measurements for a given period of time (e.g., one day) are represented as a series of values, wherein each value corresponds to one interval during the period (e.g., an hour, a fraction of an hour) and comprises a percentage, ratio, fraction, or other value reflecting a relation between the accumulated work during the interval as compared to work accumulated during the entire period.

For example, at a given time corresponding to one interval (e.g., an hour), or during the interval, if the forecasted accumulated work amounts to 10% of the maximum accumulated work forecast for the entire period (e.g., the day), or of the total accumulated work over all intervals of that period, that interval's value is set accordingly. In different embodiments, profiles of accumulated work may take different forms, not all of which are identified herein.

In operation 206, a request is received or identified to shut down the component, or to perform some action (e.g., a software upgrade) that will disrupt the component's normal operations. In some implementations, the request includes or is accompanied by a level of urgency. In other implementations, a level of urgency is assigned to the request after it is received.

A requirement for an immediate shutdown (e.g., for safety reasons), for example, would have the highest possible urgency, and may obviate any need for scheduling a suitable time. Otherwise, the urgency level may identify or be used to identify a period of time within which the request should or must be satisfied. In some implementations, a requirement to disrupt operation of the cluster may specify a time window during which the disruption should occur, or a latest time by which it should occur, thereby inherently identifying the urgency of the requirement.

In an illustrative implementation, an urgent (but not emergency) request may require or merit a shutdown within a few hours, a routine request may indicate that a shutdown should be performed within 48 hours, and a low-priority request may allow for up to a week before the component's operations must be disrupted. Other implementations may vary widely.

The urgency of a request may be expressed in terms of time (e.g., a period of time within which the disruption is required or desired), a scale (e.g., from 0 to 5, from 1 to 10), a description (e.g., “urgent,” “normal”), or in some other way. A request that is not accompanied by an indication of its urgency may be assigned a default level (e.g., by an operator or administrator of the component).

In operation 208, based on the request and any associated urgency level, a target level or threshold of accumulated work is identified that is considered suitable for disruption operation of the cluster. In the illustrated embodiments, the higher the urgency of the request, the higher the level of accumulated work may be and still be a suitable time for the shutdown.

For example, an urgent shutdown that must be performed within a few hours may be performed even when the forecasted accumulated work will be relatively high. Conversely, for a low-priority request that need not be satisfied for days or several hours, a shutdown may be postponed until a relatively low level of accumulated work is forecasted (e.g., the lowest level forecast for the entire window of time during which the disruption should or must occur).

In some embodiments, the target level is identified as a measure of accumulated work, in terms of execution time (e.g., minutes, hours, task-minutes, task-hours) and/or resource usage (e.g., memory usage, storage space, network bandwidth). Alternatively, the target level may be expressed as a quantile or percentage (e.g., if a forecast is expressed as a probability distribution function), or in some other way.

In operation 210, the disruption to component operations is scheduled for a time that meets the target level requirement, based on forecasted work accumulations for the component. For example, within the period of time allowed by the urgency associated with the disruption, the time of the lowest forecast work accumulation that satisfies the target level may be selected. As one alternative, the earliest (or latest) time in the period at which the forecasted work accumulation will satisfy the target level may be selected. In different embodiments, the time for the disruption may be selected in different ways, subject to the window of time or time frame in which the disruption is necessary or desired, and the allowable or suitable level of accumulated work that may be disrupted.

Notices regarding the pending shutdown may be dispatched to some or all users of the component, as is customary. In some embodiments, if no prior notifications (e.g., to users, clients) are necessary or desired, a disruption may be dynamically (e.g., and automatically) implemented if and when a current level of accumulated work in the cluster drops below the target level of accumulated work.

In some embodiments, after the disruption is complete, and the component is once again online and operational, some or all tasks (or jobs or other work objects) may be automatically resubmitted without the submitting users having to take action. In these embodiments, therefore, necessary information regarding jobs that users submit is retained until the jobs are complete (e.g., execution parameters, reporting formats).

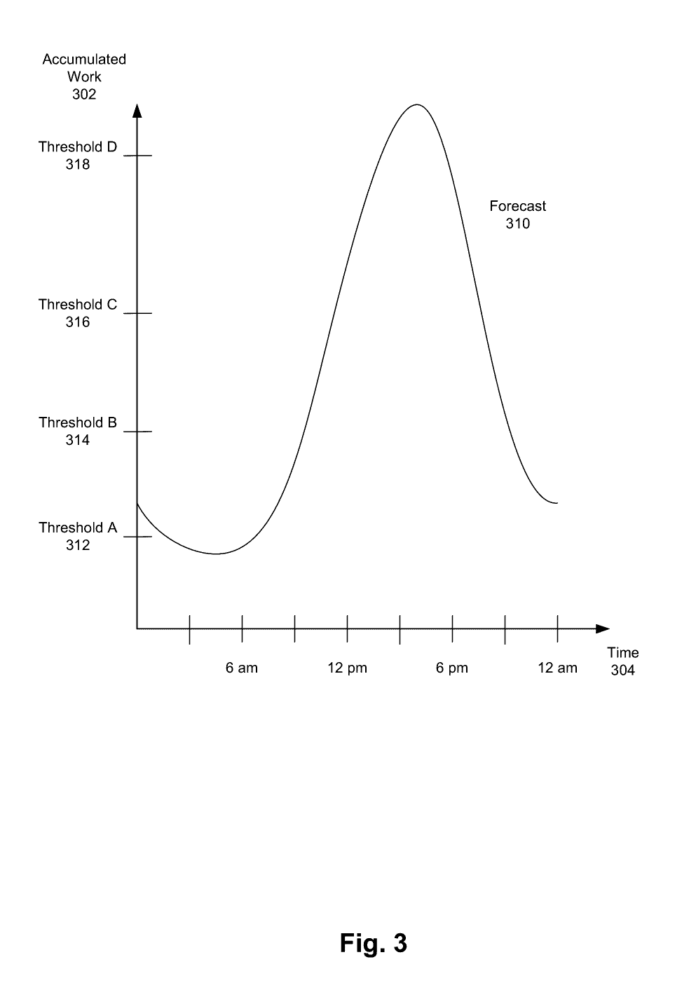

FIG. 3 depicts an illustrative forecast of work accumulation on a computing system component, according to some embodiments.

Forecast 310 of FIG. 3 is in the form of a graph representing predicted or forecasted accumulated work 302 over time 304, for an illustrative computing system component (or system, subsystem, etc.). As discussed previously, the forecasted accumulated work represented by forecast 310 may be time measurements, resource measurements, quantiles, or other units/measures.

Regardless of how the accumulated work forecasts are expressed, forecast 310 indicates that, for the twenty-four hour period encompassed by the forecast, the lowest level of accumulated work will occur between 3 am and 6 am, and the peak level of accumulated work will occur between 3 pm and 6 pm.

Four threshold levels are identified (threshold A 312, threshold B 314, threshold C 316, and threshold D 318), which may correspond to different urgencies that may be assigned to or associated with requests to disrupt (e.g., shut down, take offline) the component. For example, a routine or low-priority disruption may be associated with threshold A 312, meaning that if a low-priority disruption were to be scheduled during the time period covered by forecast 310, it would be scheduled between approximately 1:30 am and approximately 6:45 am. Conversely, a high-priority disruption may correspond to threshold D 318, and could be scheduled at almost any time during the forecast period except between approximately 2:00 pm and 5:30 pm.

In some embodiments, forecasts for different periods may be in the form of graphs having other shapes and/or magnitudes, but threshold levels may remain fixed. As a result, another forecast may not feature any accumulated work that falls below threshold A 312 (and/or other thresholds), in which case no low-priority disruptions would normally be scheduled during the period of time corresponding to the other forecast.

A very high-priority disruption (e.g., an emergency) shutdown may be associated with an accumulated work threshold that exceeds every accumulated work forecast (e.g., infinity), in which case such a disruption could be implemented immediately and automatically upon receipt.

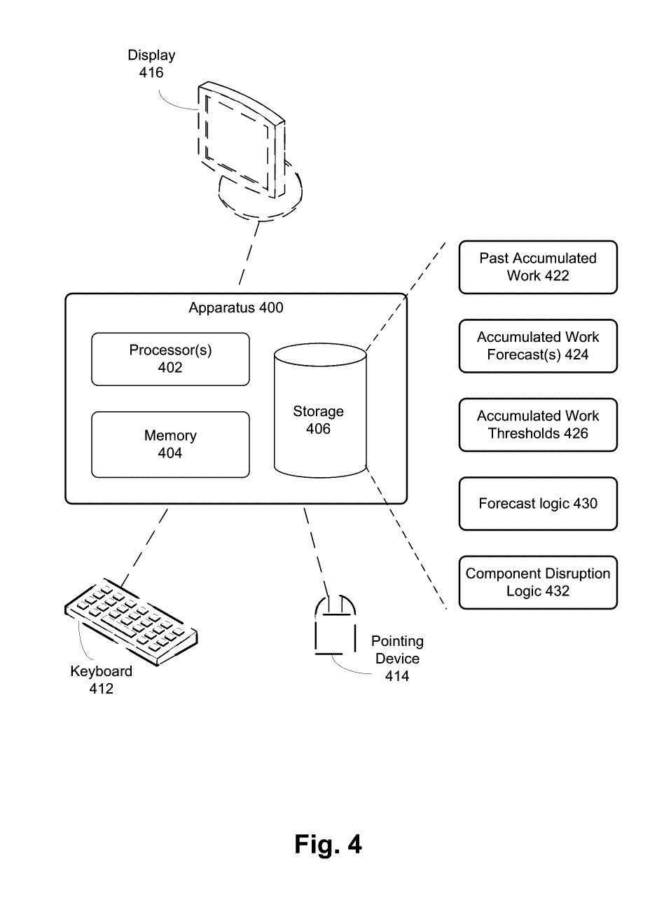

FIG. 4 depicts an apparatus for scheduling a disruption to the operation of a computing system component based on an actual or projected level of accumulated work, according to some embodiments.

Apparatus 400 of FIG. 4 includes processor(s) 402, memory 404, and storage 406, which may comprise one or more optical, solid-state, and/or magnetic storage components. Storage 406 may be local to or remote from the apparatus. Apparatus 400 can be coupled (permanently or temporarily) to keyboard 412, pointing device 414, and display 416.

Storage 406 stores data used by apparatus 400 to enable determinations of appropriate or optimal times to disrupt operations of apparatus 400, a component of apparatus 400, and/or a computing system component external to apparatus 400. The data includes past measurements 422 and/or a profile of accumulated work, forecasts or models of future accumulated work, and accumulated work thresholds 426 for association with disruption requests.

Storage 406 also stores logic and/or logic modules that may be loaded into memory 404 for execution by processor(s) 402, such as forecast logic 430 and component disruption logic 432. In other embodiments, any or all of these logic modules may be aggregated or divided to combine or separate functionality as desired or as appropriate.

Forecast logic 430 comprises processor-executable instructions for generating an accumulated work forecast 424 from some or all of accumulated work measurements data 422. Logic 430 may therefore implement any suitable machine-learning model or artificial intelligence for making forecasts or calculating probabilities based on historical data.

Component disruption logic 432 comprises processor-executable instructions for receiving a disruption request and automatically or manually identifying a suitable accumulated work threshold 426 for implementing the requested disruption (e.g., based on a priority or urgency of the disruption) and scheduling the disruption. Scheduling the disruption may include dispatching communications to some or all users of the component to be disrupted.

In some embodiments, apparatus 400 performs some or all of the functions ascribed to one or more components of system 110 of FIG. 1.

Optional additional logic for automatically resubmitting work that was terminated by the disruption may be included in logic 432 or may be maintained as a separate logic module.

An environment in which one or more embodiments described above are executed may incorporate a data center, a general-purpose computer or a special-purpose device such as a hand-held computer or communication device. Some details of such devices (e.g., processor, memory, data storage, display) may be omitted for the sake of clarity. A component such as a processor or memory to which one or more tasks or functions are attributed may be a general component temporarily configured to perform the specified task or function, or may be a specific component manufactured to perform the task or function. The term “processor” as used herein refers to one or more electronic circuits, devices, chips, processing cores and/or other components configured to process data and/or computer program code.

Data structures and program code described in this detailed description are typically stored on a non-transitory computer-readable storage medium, which may be any device or medium that can store code and/or data for use by a computer system. Non-transitory computer-readable storage media include, but are not limited to, volatile memory; non-volatile memory; electrical, magnetic, and optical storage devices such as disk drives, magnetic tape, CDs (compact discs) and DVDs (digital versatile discs or digital video discs), solid-state drives, and/or other non-transitory computer-readable media now known or later developed.

Methods and processes described in the detailed description can be embodied as code and/or data, which may be stored in a non-transitory computer-readable storage medium as described above. When a processor or computer system reads and executes the code and manipulates the data stored on the medium, the processor or computer system performs the methods and processes embodied as code and data structures and stored within the medium.

Furthermore, the methods and processes may be programmed into hardware modules such as, but not limited to, application-specific integrated circuit (ASIC) chips, field-programmable gate arrays (FPGAs), and other programmable-logic devices now known or hereafter developed. When such a hardware module is activated, it performs the methods and processed included within the module.

The foregoing embodiments have been presented for purposes of illustration and description only. They are not intended to be exhaustive or to limit this disclosure to the forms disclosed. Accordingly, many modifications and variations will be apparent to practitioners skilled in the art. The scope is defined by the appended claims, not the preceding disclosure.

1. A method comprising:
forecasting accumulated work within a computing system component;
identifying a requirement to disrupt operation of the component, wherein the requirement specifies a time window during which the disruption should occur or a latest time by which the disruption should occur;
associating with the requirement a target threshold of accumulated work; and
scheduling the disruption for a time when the forecasted accumulated work is less than the target threshold.

2. The method of claim 1, wherein accumulated work within the component at a given time is a measure of processing initiated on the component but not finished as of the given time.

3. The method of claim 1, wherein:
the component is a data processing cluster that executes logic to:
receive jobs submitted by clients; and
for each submitted job, execute one or more associated tasks to perform processing required in order to complete the job; and
accumulated work within the component at a given time comprises, for each job submitted to the processing cluster that has not completed by the given time:
work performed by associated tasks executing at the given time;
work performed by associated tasks awaiting execution at the given time; and
work performed by associated tasks that have completed execution by the given time.

4. The method of claim 3, wherein the data processing cluster comprises:
multiple data nodes that execute the tasks associated with the submitted jobs;
a first node managing a namespace encompassing the multiple data nodes; and
a second node scheduling the tasks to data nodes.

5. The method of claim 1, wherein said forecasting comprises:
at each of multiple intervals during a period of time, measuring accumulated work within the component; and
applying a machine-learning model to the measurements of accumulated work.

6. The method of claim 1, wherein:
said identifying comprises receiving a request that requires disruption to the operation of the component, said request having an associated urgency; and
said associating comprises selecting the target threshold among multiple candidate thresholds of accumulated work, based on the associated urgency.

7. The method of claim 6, wherein the associated urgency corresponds to a period of time during which the disruption must occur.

8. An apparatus, comprising:
one or more processors; and
memory storing instructions that, when executed by the one or more processors, cause the apparatus to:
forecast accumulated work within a computing system component;
identify a requirement to disrupt operation of the component, wherein the requirement specifies a time window during which the disruption should occur or a latest time by which the disruption should occur;
associate with the requirement a target threshold of accumulated work; and
schedule the disruption for a time when the forecasted accumulated work is less than the target threshold.

9. The apparatus of claim 8, wherein accumulated work within the component at a given time is a measure of processing initiated on the component but not finished as of the given time.

10. The apparatus of claim 8, wherein:
the component is a data processing cluster that executes logic to:
receive jobs submitted by clients; and
for each submitted job, execute one or more associated tasks to perform processing required in order to complete the job; and
accumulated work within the component at a given time comprises, for each job submitted to the processing cluster that has not completed by the given time:
work performed by associated tasks executing at the given time;
work performed by associated tasks awaiting execution at the given time; and
work performed by associated tasks that have completed execution by the given time.

11. The apparatus of claim 10, wherein the data processing cluster comprises:
multiple data nodes that execute the tasks associated with the submitted jobs;
a first node managing a namespace encompassing the multiple data nodes; and
a second node scheduling the tasks to data nodes.

12. The apparatus of claim 8, wherein said forecasting comprises:
at each of multiple intervals during a period of time, measuring accumulated work within the component; and
applying a machine-learning model to the measurements of accumulated work.

13. The apparatus of claim 8, wherein:
said identifying comprises receiving a request that requires disruption to the operation of the component, said request having an associated urgency; and
said associating comprises selecting the target threshold among multiple candidate thresholds of accumulated work, based on the associated urgency.

14. The apparatus of claim 13, wherein the associated urgency corresponds to a period of time during which the disruption must occur.

15. A system, comprising:
one or more processors;
a forecasting logic module comprising a non-transitory computer-readable medium storing instructions that, when executed, cause the system to forecast accumulated work within a computing system component; and
a component disruption logic module comprising a non-transitory computer-readable medium storing instructions that, when executed, cause the system to:
identify a requirement to disrupt operation of the component, wherein the requirement specifies a time window during which the disruption should occur or a latest time by which the disruption should occur;
associate with the requirement a target threshold of accumulated work; and
schedule the disruption for a time when the forecasted accumulated work is less than the target threshold.

16. The system of claim 15, wherein accumulated work within the component at a given time is a measure of processing initiated on the component but not finished as of the given time.

17. The system of claim 15, wherein:
the component is a data processing cluster that executes logic to:
receive jobs submitted by clients; and
for each submitted job, execute one or more associated tasks to perform processing required in order to complete the job; and
accumulated work within the component at a given time comprises, for each job submitted to the processing cluster that has not completed by the given time:
work performed by associated tasks executing at the given time;
work performed by associated tasks awaiting execution at the given time; and
work performed by associated tasks that have completed execution by the given time.

18. The system of claim 17, wherein the data processing cluster comprises:
multiple data nodes that execute the tasks associated with the submitted jobs;
a first node managing a namespace encompassing the multiple data nodes; and
a second node scheduling the tasks to data nodes.

19. The system of claim 15, wherein said forecasting comprises:
at each of multiple intervals during a period of time, measuring accumulated work within the component; and
applying a machine-learning model to the measurements of accumulated work.

20. The system of claim 15, wherein:
said identifying comprises receiving a request that requires disruption to the operation of the component, said request having an associated urgency; and
said associating comprises selecting the target threshold among multiple candidate thresholds of accumulated work, based on the associated urgency.
